(19) United States
(12) Patent Application Publication
(10) Pub. No.: US 2006/0049629 A1
(43) Pub. Date: Mar. 9, 2006

(54) Coupling unit with magnetic latching

(75) Inventors: Volker Naumann, Bad Orb (DE); Thomas Rosch, Linsengericht-Waldrode (DE)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Veritas AG, Gelnhausen (DE)

(21) Appl. No.: 11/178,322

(22) Filed: Jul. 12, 2005

(30) Foreign Application Priority Data
Aug. 17, 2004 (DE) 10 2004 039 857.7

(51) Int. Cl. F16L 37/00

(52) U.S. Cl. 285/308

(57) ABSTRACT

The invention relates to a coupling unit for tubes o the like, comprising a coupling body with an opening for receiving therein a tube, and a latching device which is adapted to be transferred between: an unlatched position in which the tube is adapted to be moved relative to the coupling body, and a latched position in which the tube is adapted to be secured in the coupling body against removal therefrom. In order to improve the known latching systems for coupling units in the case of a crash or fire, the invention provides a coupling unit of the type referred to at the beginning, in which the latching device is magnetically operable for transfer between the unlatched position and the latched position and/or between the latched position and the unlatched position.

The invention relates to a coupling unit for tubes o the like, comprising a coupling body with an opening for receiving therein a tube, and a latching device which is adapted to be transferred between:
an unlatched position in which the tube is adapted to be moved relative to the coupling body, and
a latched position in which the tube is adapted to be secured in the coupling body against removal therefrom,

A coupling unit of this type is known e.g. from EP 1 154 190 A2. This patent discloses a plug-in coupling for tubes with a twofold mechanical latching device.

Such tube couplings are preferably used in the field of automobiles, in the area where the fuel is supplied to the engine. They are also known as quick connectors and they are characteristically implemented such that fuel conducting elements can be connected with little mounting effort. The use of such coupling units leads, however, to great safety problems when, e.g. during maintenance work, the fuel-conducting elements are separated under the influence of shocks or impacts at the coupling points. Especially in the case of a crash, where the couplings are sometimes acted upon by extreme mechanical forces, it may happen that the latching devices becomes unlatched and that the fuel-conducting elements become detached from one another. The fuel escaping from said elements represents, especially in the case of fire, an enormous safety risk.

It is the object of the present invention to improve the known latching systems for coupling units in the case of a crash or in the case of fire.

In order to achieve this object, the invention provides a coupling unit of the type referred to at the beginning, in which the latching device is magnetically operable for transfer from the unlatched position to the latched position and/or from the latched position to the unlatched position. In order to achieve this object, the present invention also provides a tube provided with a latching device of the type in question as well as a tool producing a magnetic field for magnetically operating the latching device of the above-mentioned coupling unit or of the above-mentioned tube so as to transfer it from the latched position to the unlatched position and/or vice versa. The latching mechanism can be latched and/or unlatched only by means of this special tool. The risk that the latching device becomes unintentionally unlatched under the influence of mechanical forces is averted in this way. Unintentional transfer from the latched position to the unlatched position is excluded.

It proves to be useful when the latching device comprises a magnetically movable means. Under the influence of the magnetic field, e.g. a metallic element can be moved such that the latching device is transferred from the latched position to the unlatched position. A large number of possible latching concepts can here be realized. Imaginable latching concepts are e.g. concepts according to which a spring-supported metallic locking element acts on a feature (e.g. annular bead, annular groove) of the tube inserted in the coupling body, thus securing the tube against removal, and the locking element is disengaged from said feature of the tube under the influence of the magnetic field and against the force of the spring, so as to allow a movement of the tube in a direction opposite to the direction of insertion.

It proves to be useful when the latching device comprises magnetically deformable means. Making use of a suitable magnetic field, it would in this way be possible to deform a component and to connect the coupling body and the tube end portion in such a way that the connection can only be released by a purposeful re-deformation or cannot be released at all without destroying the component in question. A purposeful re-deformation could e.g. be accomplished by reversing the polarity of the magnetic field which caused the purposeful deformation. Also in this case, latching concepts are e.g. imaginable according to which e.g. a metallic spring element acts on a feature (e.g. annular bead, annular groove) of the tube inserted in the coupling body, thus securing the tube against removal, the spring element itself being deformed and released from engagement with said feature of the tube under the influence of the magnetic field, so as to allow a movement of the tube in a direction opposite to the direction of insertion.

It proves to be advantageous when the latching device comprises magnetically rotatable means. Simple but effective latching concepts for axially securing the tube end portion in the coupling body, e.g. a bayonet coupling, can be realized in this way.

It also proves to be advantageous when the latching device already comprises magnetic means. These magnetic means can be purposefully influenced by the magnetic field produced by the associated tool.

It will be of advantage when the latching device is in the latched position when it is not acted upon by a magnetic field. This means that the latching device is normally closed and cannot be unlatched without the use of a special tool.

It will also be of advantage when the latching device is in the unlatched position when it is acted upon by a magnetic field. The condition of the latching device is thus directly dependent on the existence of the magnetic field.

According to a preferred embodiment, the latching device is adapted to be transferred from the latched position to the unlatched position and/or vice versa in a contactless manner. Damage that may be caused to the coupling units by direct contact with tools (e.g. wrenches, tongs, etc.) can be avoided in this way.

According to an advantageous embodiment, the latching device comprises at least one latching mechanism which allows a movement of the tube in a first direction and obstructs said movement in a second direction opposite to said first direction. This allows the coupling connection to be rapidly established in the usual way, without major mounting efforts and without using special tools, unintentional unlatching of the coupling connection being, however, excluded.

Alternatively, it proves to be useful when the latching device is attached directly to the tube. Since the latching device will then co-operate with both the coupling body and the tube, the statements made hereinbefore with regard to the advantageous embodiments apply analogously.

The present invention additionally provides a tool, which produces a magnetic field for magnetically operating the respective latching device so as to transfer it from the latched position to the unlatched position and/or from the unlatched position to the latched position.

Furthermore, the present invention provides couplings between a coupling body and a tube, in the case of which the latching device can selectively be arranged on the side of the coupling body or on the side of the tube.

Finally, the present invention provides a kit comprising a coupling of the type in question and the associated tool.

### SHORT DESCRIPTION OF THE DRAWINGS

FIG. 1a shows a representation of a first embodiment of the coupling unit according to the present invention having a tube end portion connected thereto, in the latched position, the latching device, which is provided on the side of the coupling body, comprising a magnetically movable means.

FIG. 1b shows a representation of a first embodiment of the coupling unit according to the present invention having a tool applied to the outer surface thereof, in the unlatched position, the latching device, which is provided on the side of the coupling body, comprising a magnetically movable means.

FIG. 2a shows a representation of a second embodiment of the coupling unit according to the present invention having a tube end portion connected thereto, in the latched position, the latching device, which is provided on the side of the coupling body, comprising a magnetically deformable means.

FIG. 2b shows a representation of a second embodiment of the coupling unit according to the present invention having a tool applied to the outer surface thereof, in the unlatched position, the latching device, which is provided on the side of the coupling body, comprising a magnetically deformable means.

FIG. 3a shows a representation of a third embodiment of the coupling unit according to the present invention having a tube end portion connected thereto, in the latched position, the latching device, which is provided on the side of the tube, comprising a magnetically deformable means.

FIG. 3b shows a representation of a third embodiment of the coupling unit according to the present invention having a tool applied to the outer surface thereof, in the unlatched position, the latching device, which is provided on the side of the tube, comprising a magnetically deformable means.

### DESCRIPTION OF THE PREFERRED EMBODIMENTS

The present invention is based on the concept of providing a non-mechanical safety device and latching device, respectively, for securing a tube end portion in a coupling body against removal therefrom, the latching device being magnetically operable. This will avoid inadvertent mechanical unlatching, e.g. due to shocks or impacts.

This inventive concept comprises and protects a large number of different embodiments of latching devices, which can selectively be provided on the side of the coupling body and/or on the side of the tube end portion and which may selectively comprise magnetically deformable or magnetically movable components so as to secure the tube end portion in the coupling body against removal. On the basis of these instructions, the person skilled in the art will already envisage a large number of embodiments of latching concepts which can easily be realized by him.

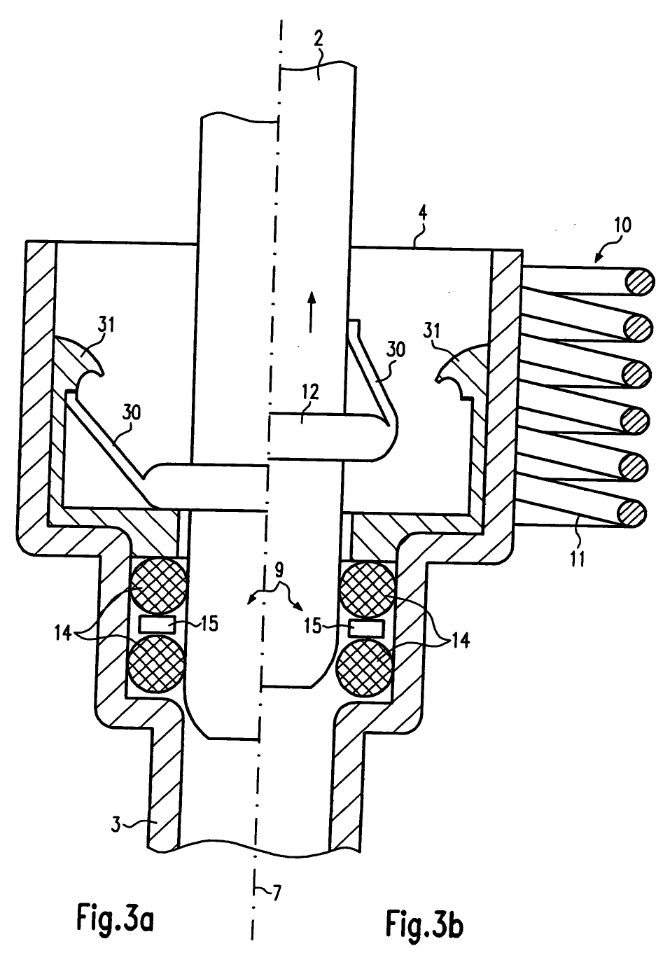

Making reference to the drawings 1a, 1b as well as 2a and 2b, two latching devices will be described, which are arranged on the side of the coupling body and which stand for the unlimited multitude of imaginable embodiments of latching concepts; the first embodiment of these latching devices comprises a magnetically movable component and the second embodiment comprises a magnetically deformable component. In FIGS. 3a and 3b, an embodiment of a latching device arranged on the side of the tube is outlined.

All the embodiments have in common that the latching devices shown are magnetically operable with the aid of a tool generating a magnetic field and used for transferring the respective latching device from the latched position to the unlatched position and/or vice versa. In the drawings, the tool is shown symbolically by a solenoid indicated in said drawings. When realizing an ideal tool, the person skilled in the art working in the technical field in question need not restrict himself to special embodiments, and he will be able to adapt the tool to the respective intended use without needing further instructions.

The respective half of the drawings located on the left hand side of the centre line 7 shows the latched condition and the half located on the right hand side shows that unlatched condition. The centre lines 7 of the coupling body 3 and of the tube end portion 2 coincide in all the representations.

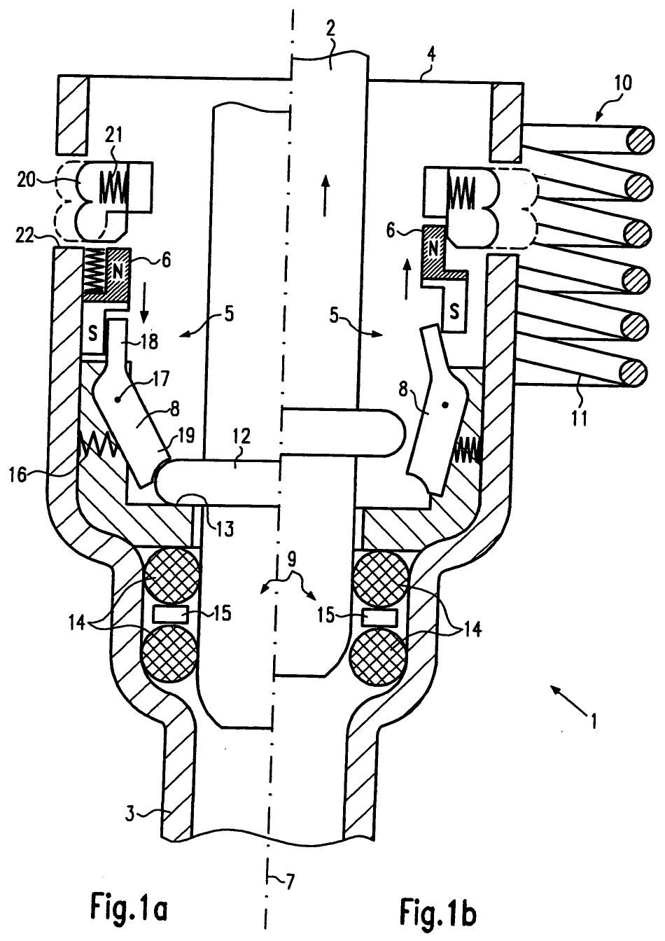

In the first embodiment shown in FIGS. 1a and 1b, the latching device 5 is arranged on the side of the coupling body 3 and comprises a magnetically movable component in the form of the permanent magnet 6. The latched condition of the coupling unit 1 will be described first. The latched condition is the coupling-unit condition in which said coupling unit 1 is not acted upon by an electromagnetic field.

FIG. 1a shows the latched condition of a coupling unit 1 according to the present invention having the tube end portion 2 connected thereto. The coupling unit 1 comprises a coupling body 3 which is substantially rotationally symmetric about the centre line 7. The coupling body 3 comprises on one side thereof—which will be referred to as reception side hereinbelow—the reception opening 4 through which the tube end portion 2 is inserted into the interior of the body. The coupling body 3 tapers in steps towards the end located opposite the reception side.

The tube end portion 2 has, on the end section located within the coupling body 3, an annular bead 12 which rests on a bearing surface 13 of a circumferentially extending shoulder in the interior of the coupling body 3 in the latched condition of the latching device 5 and which is clampingly fixed in position by the detent 8 on the side located opposite to said bearing surface 13 in the axial direction. The stop means 13 of the coupling body 3 is implemented as a substantially annular surface which extends in a plane at right angles to the coupling body axis 7.

A sealing means 9 comprising two sealing rings 14, which are spaced by a spacer sleeve 15, and located on the other side of the shoulder seals the end section of the tube end portion 2 from the coupling body 3.

In the first embodiment, the latching device 5 essentially comprises a permanent magnet 6, a detent 8 and an operating element 20.

The permanent magnet 6 is a segment of a stepped cylindrical body whose larger cylinder segment-shaped portion slidingly abuts on the (cylindrical) inner wall of the coupling body 3 in the latched condition. The smaller cylinder segment-shaped portion of the permanent magnet 6 is directed towards the reception opening 4 of the coupling body 3. The permanent magnet 6 is biased via a spring in a direction corresponding essentially to the direction of insertion. The north pole of the permanent magnet 6 faces the reception opening 4 of the coupling body 3 and occupies approximately the smaller cylinder segment-shaped portion. The south pole of the permanent magnet 6 is consequently located at the opposite axial end of the cylindrical body and covers the larger cylinder segment-shaped portion.

A detent 8 is secured to the coupling body 3 and supported such that it is rotatable about an axis 17 extending at right angles to the section plane in the representations according to FIGS. 1a and 1b. The detent 8 is a substantially hook-shaped component having two ends 18 and 19, the axis of rotation of said detent 8 being located approximately in the middle at the position of the bend. The detent end 18 facing the reception opening 4 is in engagement with the permanent magnet 6 and abuts, when seen in the radial direction, on the larger cylinder segment-shaped portion of the permanent magnet 6 from inside. The opposite detent end 19 is in engagement with the annular bead 12 of the tube end portion 2 in the latched condition. The end 19 of the detent 8 is maintained in engagement with the annular bead 12 of the tube end portion 2 by the spring force of the spring element 16 and obstructs the movement of the tube end portion 2 in a direction opposite to the direction of insertion. A self-locking latching concept is realized in this way.

An operating element or key 20, which, biased by a spring 21, projects beyond an opening 22 in the circumferential surface of the coupling body 3, can be pressed radially into the interior of the coupling body. The key 20 serves to release the detent 8 from the annular bead 12 of the tube end portion 2 so as to allow the movement of the tube end portion 2 in a direction opposite to the direction of insertion. Without the influence of the electromagnetic field, the flow of forces from the key 20 to the detent 8 is, however, interrupted and the latching mechanism 5 cannot be released mechanically by operating the key 20.

FIG. 1b shows the first embodiment in the unlatched condition. A tool 10 comprising a solenoid 11 is arranged around the coupling body, said solenoid producing a magnetic field. The magnetic field produced by the tool 10 exerts a force on the permanent magnet 6, which moves said permanent magnet 6 in a direction opposite to the spring biasing direction and opposite to the direction of insertion. The flow of forces from the key 20 to the detent 8 is then closed and the latching mechanism 5 can be unlatched by operating the key 20.

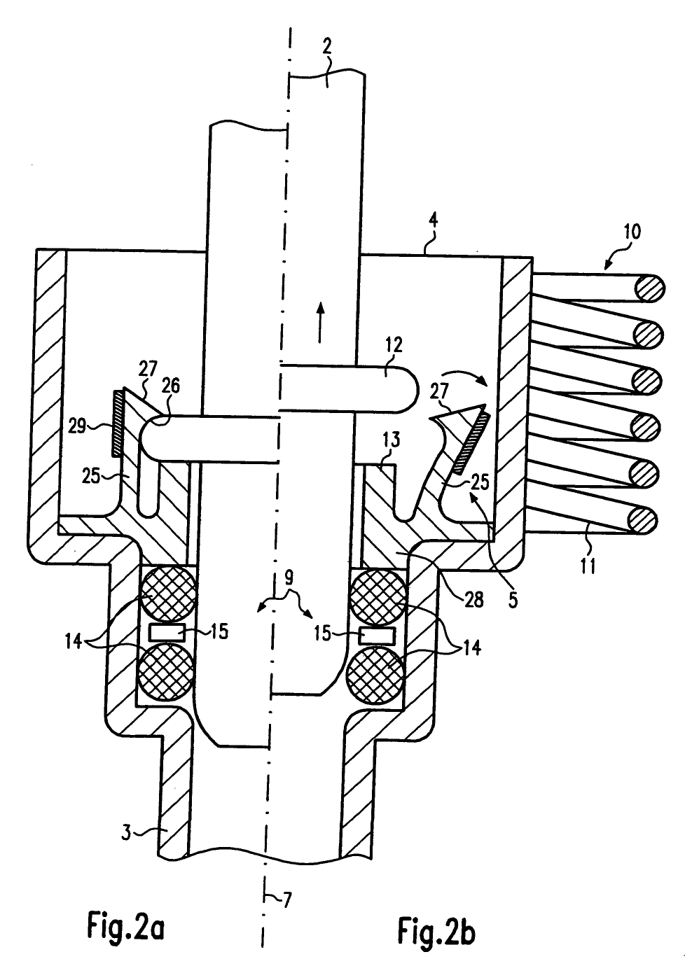

A second embodiment is described with reference to FIGS. 2a and 2b. In order to avoid redundancies, identical components are designated by the same reference numerals as in the case of the first embodiment. Also in said second embodiment, the latching device 5 is arranged on the side of the coupling body 3 and comprises a magnetically deformable component in the form of the flexible tongues 25.

FIG. 2a shows the latched condition of the coupling unit 1 comprising a coupling body 3 and a tube end portion 2 inserted in the reception opening 4 of said coupling body 3. The shape of the coupling body 3 corresponds substantially to that of the first embodiment.

The latching device 5 comprises a plurality of flexible tongues 25, which are identical in construction and which are preferably uniformly distributed around the centre line 7, said flexible tongues 25 being interconnected by the connection element 28. One flexible tongue 25, which stands for a plurality of flexible tongues, will be described hereinbelow. The flexible tongue 25 is made of a flexible, bendable material, e.g. a plastic material. It projects substantially parallel to the centre line 7 of the coupling body 3 from the connection element 28 in the direction of the reception opening 4. Preferably, the flexible tongues 25 are formed integrally with the connection element 28 and they are made of the same material. The flexible tongue end facing the reception opening 4 comprises, on the radially inner side thereof, an engagement portion 26 which is adapted to the outer contour of the annular bead 12 of the tube end portion 2 and which engages behind said annular bead 12 in the latched condition. The tube end portion 2 is in this way secured in the coupling body 3 against removal therefrom. The flexible tongue end facing the reception opening 4 comprises, on the radially outer side thereof, i.e. opposite the engagement portion 26, a metal body or magnet body 28. This metal body or magnet body 28 is e.g. glued onto the outer surface of the flexible tongue 25.

FIG. 2b shows the second embodiment of the present invention in the unlatched condition. A tool 10 producing a magnetic field is arranged on the outer surface of and around the coupling body 3. The tool 10 is symbolically represented by the solenoid 11. Due to the influence of the magnetic field acting on the magnet body 28, the flexible tongues 25 are magnetically deformed and expanded, respectively, against their spring force, so as to enlarge an opening which is delimited by the engagement portions 26 of the flexible tongues 25, whereby a movement of the tube 2 in a direction opposite to the direction of insertion is admitted.

FIGS. 3a and 3b show a third embodiment of the present invention. In said third embodiment, the latching device 5 is arranged on the side of the tube end portion 2 and comprises a magnetically deformable component in the form of the spring portions 30.

FIG. 3a shows the latched condition of the third embodiment. The tube end portion 2 has provided thereon magnetic spring portions 30 which expand in the radial direction due to their own spring force, said spring portions 30 being preferably uniformly distributed around the centre line. The spring portion ends facing the reception opening 4 of the coupling body 3 rest, in a direction opposite to the direction of insertion, on the holding element 31 provided in the coupling body, whereby the tube end portion 2 is secured in the coupling body 3 against removal therefrom.

FIG. 3b shows the unlatched condition of the third embodiment. Due to the influence of the magnetic field acting on the magnetic spring portions 30, said spring portions 30 are magnetically deformed against their spring force so that they will be released from the latched condition with the holding element 31.

In the following, the preferred possibilities of use of the described embodiments will be explained with reference to the figures.

Normally, i.e. without the influence of a magnetic field, the latching device of the coupling unit is in the latched condition, i.e. it is also latched before the tube end portion 2 and the coupling body 3 are joined. The process of joining the tube end portion 2 and the coupling body 3 will be described hereinbelow for the first embodiment with reference to FIGS. 1a and 1b.

The tube end portion 2 is inserted from the reception side into the coupling body 3 in the direction of insertion, which extends coaxially with the centre line 7. The annular bead 12 slides on the lower surface of the detent end 19 facing the centre of the body and displaces the detent 8 against the force of the spring 16. When the annular bead 12 abuts on the stop means 13, the detent 8 will be forced back by the spring force of the spring 16 and a suitably shaped portion at the end 19 of the detent 8 will abut on the annular bead 12 of the tube end portion 2. A movement of the tube end portion 2 against the direction of insertion is therefore obstructed and the tube end portion 2 is secured in the coupling body against removal therefrom.

For transferring the latching device 5 from the latched position, in which the tube 2 is secured in the coupling body 3 against removal therefrom, to the unlatched position, in which the tube 2 is adapted to be moved relative to the coupling body 3, said latching device 5 is always operated magnetically. For this purpose, a tool 10, which produces a magnetic field and which is symbolically represented by the solenoid 11, is placed in the vicinity of the coupling unit 1 where it co-operates with the latching device 5 in a suitable manner so as to transfer said latching device 5 between the latched position and the unlatched position. Due to the influence of the magnetic field produced by the tool 10, a deformable or movable component of the latching device 5 is influenced in such a way that the latching device 5 will be transferred from the latched position to the unlatched position and/or vice versa.

The effect produced by the influence of the magnetic field is, in the first embodiment, an effect which closes the flow of forces between the key 20 and the detent 8 through the magnetically movable component, the permanent magnet 6, so as to transmit the movement of the key 20 to the detent 8. By operating the key 20 from outside, the movement of said key 20 will be transmitted through the permanent magnet 6 to the detent end 18 facing the reception opening 4 of the coupling body 3. Due to the rotational movement of the detent 8, the detent end 19 will be released from the annular bead 12 of the tube end portion against the spring force of the spring 16 and allow a movement of the tube end portion 2 in a direction opposite to the direction of insertion (arrow).

Also the other embodiments show similar self-locking latching concepts, which allow an insertion movement of the tube end portion 2 in the direction of insertion and obstruct a movement in a direction opposite to the direction of insertion. Such a latching concept is, in most cases, realized in that, due to a feature (e.g. an annular bead or groove) of the tube end portion, a spring device is deformed (e.g. compressed or expanded) during insertion of the tube end portion, and in that the tube end portion, after having reached the latched position (e.g. stop position), rests on the spring device via the respective feature in a direction opposite to the direction of insertion. Such self-locking latching concepts are, in principle, known and are described only briefly within the framework of the present invention.

In the second embodiment, which is shown in FIGS. 2a and 2b, the tube end portion 2 is again inserted into the coupling body 3 from the reception side through the reception opening 4. The oblique surface 27 on the engagement portion 26 of the flexible tongue 25 is provided for causing the annular bead 12 of the tube end portion 2, which is in the process of being inserted in the coupling body 3, to slide therealong and to expand the flexible tongues 25 to such an extent that the annular bead 12 is allowed to pass the opening delimited by the engagement portions 26 of said flexible tongues 25. When the annular bead 12 has fully passed through the opening delimited by the engagement portions 26 of the flexible tongues 25, said flexible tongues 25 will—due to their own spring force—engage behind the annular bead 12 and secure the tube 2 in the coupling body 3 against removal therefrom.

When a certain magnetic field acts on the metal body or the magnet body 28, the flexible tongue 25 will expand outwards and release the annular bead 12 of the tube end portion 2. Such an unlatched condition is shown in FIG. 2b. In this condition, the tube end portion 2 can be moved relative to and removed from the coupling body 3 in a direction opposite to the direction of insertion.

In the third embodiment, which is shown in FIGS. 3a and 3b, the spring portions 30 slide on the bevelled surfaces of the holding elements 31 during insertion of the tube end portion 2 in the coupling body, and become deformed against their own spring force. After having passed the smallest cross-section defined by the holding element 31, the spring portions 30 will expand, due to their own spring force, and rest on a bearing surface on the holding element 31 in a direction opposite to the direction of insertion so as to secure the tube end portion 2 in the coupling body 3 against removal therefrom.

For transferring the latching device 5 from the latched position to the unlatched position, the tool 10, which is symbolically represented by the solenoid 11, is placed in the vicinity of the coupling unit 1 where it co-operates with the magnetic spring portions 30 in such a way that said spring portions 30 will be deformed against their own spring force and permit the tube end portion 2 to be withdrawn from the coupling body 3.

It is also possible to realize a coupling unit comprising a magnetically rotatable component within the scope of the same inventive concept. A magnetically operable bayonet coupling could e.g. be provided for securing the tube end portion in the coupling body against removal therefrom. The latching device according to the present invention need not necessarily be the only locking device of the coupling unit. For improving the reliability of a coupling connection still further, it is definitely advisable to use e.g. an additional, e.g. mechanical locking device (secondary latch).

1. A coupling unit for tubes or the like, comprising a coupling body with an opening for receiving therein a tube, and a latching device which is adapted to be transferred between:
an unlatched position in which the tube is adapted to be moved relative to the coupling body, and
a latched position in which the tube is adapted to be secured in the coupling body against removal therefrom,
wherein the latching device is magnetically operable for transfer between the unlatched position and the latched position and/or between the latched position and the unlatched position.

2. A coupling unit according to claim 1, wherein the latching device comprises a magnetically deformable unit.

3. A coupling unit according to claim 1, wherein the latching device comprises magnetically movable means.

4. A coupling unit according to claim 1, wherein the latching device comprises magnetically rotatable means.

5. A coupling unit according to claim 1, wherein the latching device comprises magnetic means.

6. A coupling unit according to claim 1, wherein the latching device is in the unlatched position when it is acted upon by a magnetic field.

7. A coupling unit according to claim 1, wherein the latching device is in the latched position when it is not acted upon by a magnetic field.

8. A coupling unit according to claim 1, wherein the latching device is adapted to be transferred from the latched position to the unlatched position in a contactless manner.

9. A coupling unit according to claim 1, wherein the latching device comprises at least one latching mechanism which allows a movement of the tube into the interior of the coupling body in a first direction and obstructs a movement of said tube in a second direction opposite to said first direction.

10. A coupling between a coupling unit according to claim 1 and a tube.

11. A tube comprising a latching device for latching the tube to a coupling unit, said latching device being adapted to be transferred between:
an unlatched position in which the tube is adapted to be moved relative to the coupling unit and
a latched position in which the tube is adapted to be secured in the coupling unit against removal therefrom,
wherein the latching device is magnetically operable for transfer between said unlatched position and said latched position and/or between said latched position and said unlatched position.

12. A tube according to claim 11, wherein the latching device comprises magnetically deformable means.

13. A tube according to claim 11, wherein the latching device comprises magnetically movable means.

14. A tube according to claim 11, wherein the latching device comprises magnetically rotatable means.

15. A tube according to claim 11, wherein the latching device comprises magnetic means.

16. A coupling between a tube according to claim 11 and a coupling body.

17. A tool for said latching device according to claim 1, wherein the tool produces a magnetic field for magnetically operating the latching device so as to transfer it from the latched position to the unlatched position and/or from the unlatched position to the latched position.

18. A kit comprising a coupling according to claim 9 and a tool for said latching device, wherein the tool produces a magnetic field for magnetically operating the latching device so as to transfer it from the latched position to the unlatched position and/or from the unlatched position to the latched position.

19. A kit comprising a coupling according to claim 16 and a tool for said latching device, wherein the tool produces a magnetic field for magnetically operating the latching device so as to transfer it from the latched position to the unlatched position and/or from the unlatched position to the latched position.
